(19) United States
(12) Patent Application Publication
(10) Pub. No.: US 2005/0004899 A1
(43) Pub. Date: Jan. 6, 2005

(54) Auditing method and service

(76) Inventors: Adrian Baldwin, Bristol (GB); Simon Shiu, Bristol (GB)

Correspondence Address: HEWLETT-PACKARD COMPANY;Intellectual Property Administration, P.O. Box 272400, Fort Collins, CO, 80527-2400, US

(21) Appl. No.: 10/832,955

(22) Filed: Apr. 27, 2004

(30) Foreign Application Priority Data
Apr. 29, 2003 (GB) 0309853.0

(51) Int. Cl. G06F 7/00

(52) U.S. Cl. 707/3

(57) ABSTRACT

A method of producing an audit record of at least one event, comprises: creating a message comprising: data relating to said event; a digest data; a time data; and signing said event data, digest data, and time data.

### FIELD OF THE INVENTION

The present invention relates to computer systems, and particularly, although not exclusively to a method and apparatus for the sharing of audit information.

### BACKGROUND OF THE INVENTION

Known data center computers for storing large amounts of data can record events by storing to a log file. Typically, the log file may comprise an item of hardware which records data describing events, where the data recorded in the log file can not be retrospectively changed or altered. Known log file data systems do provide a reliable record of events in a computing system. However, these systems have a problem that large amounts of data are recorded, which makes them difficult to use.

In known systems, where a user interacts with an IT system, any evidence of what the user did, or any evidence of what the IT system did on behalf of the user becomes immersed in all of the log files of the computer entities of the IT system. Consequently, obtaining a self-consistent and complete record of activities relating to a user involves searching every log file of every computer entity in an IT system, which is impractical.

Another known system for providing a record of events in a computing system is receipting. In a known receipting system, when a user carries out a transaction, the user receives an electronic receipt for that transaction which can be used as proof of the transaction. Such receipts can be made secure, so as to be incapable of being changed retrospectively.

In the known receipting system, a user of the system has responsibility for maintaining the storage of their own receipts relating to transactions which they have carried out. However receipting solutions pass many data management problems to the customer and become complicated when multiple parties need access to the same non-repudiation data.

Known quality assurance methods are based upon showing due diligence of a process as being a best guarantee for the completeness and integrity of a data which is being viewed. It is known to use time stamping and hash tree techniques for preserving the integrity and non-repudiation of data. Examples can be found in ‘The Hand Book of Applied Cryptography’ by Menezes et al.

Referring to FIG. 1 herein, there is illustrated schematically operation of a known time stamping service, operable for time stamping and signing an event. An information technology (IT) system 100 generates an event 101 and sends this to a timestamp server 102 operated by a timestamp authority (TSA). The timestamp server contains a trusted clock, and a digital key. The timestamp server stamps the event to produce a stamped and timed event 103 which includes the event data, a timestamp data, and a digital signature of the time stamping service. Examples of known time stamping authorities providing such a service include Surity.com. Systems for providing a timestamp to events are known in an IETF standard. However using such time stamping systems for known types of auditable data, where events are sent over the internet to a centralised time stamping server, generates large volumes of traffic between the IT system and the time stamp server.

In a further known development, time stamping and key signature functionality is separated off into a secure hardware device which is provided to a user, so that the user can have a local time stamping and key signature service for events provided through a trusted hardware device which is local to the user.

The prior art does not address the issue of sharing audit data and creation of audit structures which can demonstrate integrity and completeness of collections of events.

### SUMMARY OF THE INVENTION

Specific implementations herein may combine auditing and receipting in such a manner that a third party computer entity or third party computer system can maintain audit data on behalf of a user, and be able to demonstrate that the data is part of an overall chain of events, and provide the audited/receipted data as a service to a user.

The service may enable the user to see evidence of events or transactions of the user, without the need to search through a large log file. An event record can be maintained by a third party computer entity or computer system, the event record being accessible by a user so that the user can check whether events have occurred, and check details of those events. Under circumstances of a dispute about the details of a transaction, or event, the third party service may provide data describing that event or transaction in a form which is non-repudiable.

Specific embodiments may combine elements of auditing and receipting in a system of computer entities, in a manner in which a user of the system can rely upon the system to keep receipt data safely on behalf of a user, so that the user does not incur the burden of storing many receipts.

Specific embodiments may provide a system for supporting the sharing of order information, which allows users to obtain relevant parts of an audit trail, verify the integrity of each part, verify that each part is a part of the audit trail, and that those parts are a complete retrieval of relevant information from the whole audit trail.

Specific embodiments may achieve supporting the sharing of order information, by interleaving events in chains and time stamping each individual block.

According to a first aspect, there is provided a method for verifying at least one event record, said method comprising: receiving a said event record from a user; retrieving an audit record corresponding to said at least one event record; retrieving a full set of event records corresponding to said audit record, and for a same attribute value as specified for said event record; for each said event record of said set, generating a digest of said event record and searching for said digest value in an audit record relating to a next event record in said set of event records; and confirming whether said event record is true or false, by comparing said digest of said event record with a digest value found in said audit record.

According to a second aspect, there is provided a service for verifying at least one event record, said service comprising the operations of: receiving a request for events according to a specified attribute value; (ii) retrieving a full set of records according to said specified attribute value contained in said request; (iii) generating a digest value for a record of said set; and (iv) checking that said, generated digest value matches a digest value contained in another record of said set.

According to a third aspect, there is provided a method of producing an audit record of at least one event, said method comprising: creating a record comprising: data relating to said event; a digest data; a time data; and signing said event data, digest data, and time data.

According to a fourth aspect, there is provided an audit record comprising: an event data describing an event; a digest data; a time stamp data; and a digital signature.

According to a fifth aspect, there is provided a method of generating a verifiable set of audit records, said method comprising: generating a first audit record comprising at least one attribute having a value and a unique identifier data; generating a second audit record comprising, a second event data; said attribute having said attribute value; and a digest of said first audit record.

According to a sixth aspect, there is provided a method of verifying that a set of audit records consists of a complete set, said method comprising: for a first said audit record; extracting a digest value from said audit record; selecting an immediately preceding audit record from said set; generating a digest value of said immediately preceding audit record; comparing said generated digest value with said digest value of said first audit record.

According to a seventh aspect, there is provided an audit system comprising: an event database capable of storing a plurality of event records, each said event record evidencing an event; an audit management system, said audit management system operable for generating an audit record, said audit record comprising: data relating to said event; a digest of said event data; a timestamp data; and a digital signature.

According to an eighth aspect, there is provided a computer program comprising program instructions for: creating a record comprising, data relating to an event; a digest data; a timestamp data; and a signature applied to said event data, digest date and timestamp data.

According to a ninth aspect, there is provided a computer program comprising program instructions for generating a verifiable set of audit records by; generating a first audit record comprising at least one attribute having a value and a unique identifier data; generating a second audit record comprising; a second event data; said attribute having said attribute value; and a digest of said first audit record.

According to a tenth aspect, there is provided a computer program comprising program instructions for verifying that a set of audit records consists of a compete set, by: extracting a digest value from an audit record; selecting an immediately preceding audit record from said set of audit records; generating a digest value of said immediately preceding audit records; and comparing said generated digest value with said digest value of said first audit record.

According to an eleventh aspect, there is provided a computer program comprising program instructions for providing a verifiable record of an event by: receiving an event message, said event message comprising data describing an event; creating an audit record from said event data, said audit record comprising: said event data; a chaining data identifying a position of said audit record in a chain of said audit records; a timestamp data indicating a time of receipt of said event data; and a digital signature.

According to a twelfth aspect, there is provided a computer program comprising instructions for verifying at least one event record by: receiving a said event record from a user; retrieving an audit record corresponding to said event record; retrieving a full set of event records corresponding to said audit record, and for a same attribute value as specified for said event records; for each said event record of said set, generating a digest of said event record and searching for said digest value in an audit record relating to a next event record in said set of event records; and confirming whether said event record is true or false, by comparing said digest of said event record with a digest value found in said audit record.

According to a thirteenth aspect, there is provided an audit service for providing a verifiable record of an event, said audit service comprising the operations of: receiving an event message said event message comprising data describing an event; creating an audit record from said event data, said audit record comprising: said event data; a chaining data identifying a position of said audit record in a chain of said audit records; a timestamp data indicating a time of receipt of said event data by said audit service; and a digital signature.

According to a fourteenth aspect, there is provided an audit service for providing a verifiable record of a plurality of events, and an integrity between those events, said audit service comprising the operations of: receiving a plurality of event messages, each said event message comprising data describing a corresponding respective event; creating a respective audit record from each of said event messages, said audit record comprising: an event data contained within said event message; a chaining data identifying a position of said audit record in a chain of said audit records; a timestamp data indicating a time of receipt of said event message by said audit service; and a digital signature.

Other aspects are as recited in the claims herein.

### BRIEF DESCRIPTION OF THE DRAWINGS

For a better understanding of the invention and to show how the same may be carried into effect, there will now be described by way of example only, specific embodiments, methods and processes with reference to the accompanying drawings in which:

FIG. 1 illustrates schematically operation of a known timestamping service for timestamping and signing events occurring in an IT system;

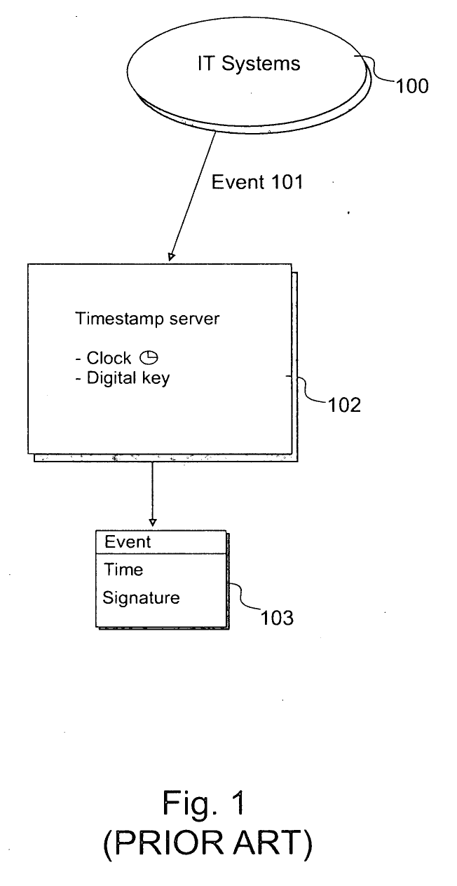

FIG. 2 illustrates schematically an audit system according to a first specific embodiment for providing a non-repudiable audit service;

FIG. 3 illustrates schematically a domain view of the audit system of FIG. 2;

FIG. 4 illustrates schematically generation of an audit message from an event using the audit system of FIG. 2;

FIG. 5 illustrates schematically process steps carried out by the audit system for generating an audit message from an event message;

FIG. 6 illustrates schematically processes carried out by the audit system of FIG. 2, for creating a record in an audit database;

FIG. 7 illustrates schematically a portion of an audit tree comprising a plurality of blocks of hashes of events and/or hashes of other blocks;

FIG. 8 illustrates schematically, packaging of a series of audit events relating to a particular attribute value;

FIG. 9 illustrates schematically layers of an hierarchical audit tree structure;

FIG. 10 illustrates schematically processes operated by an audit system for creating the hierarchical audit tree structure of FIG. 9;

FIG. 11 illustrates schematically a process carried out by the audit system for checking whether an event evidenced by an audit record is verified as being true or not;

FIG. 12 illustrates schematically referral of an audit record to an audit system by a user for verification of the audit record, the user having obtained the audit record from an IT system;

FIG. 13 illustrates schematically verification of an event within a top level chain of events;

FIG. 14 illustrates schematically verification of whether an event is part of an audit trail; and

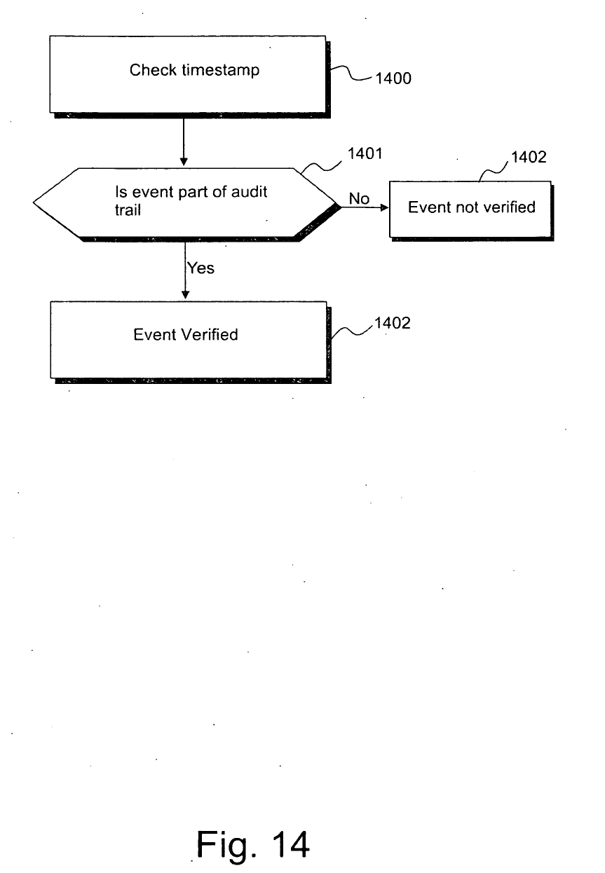

FIG. 15 illustrates schematically chaining of audit records, in a manner in which an integrity of the whole chain of audit records is verifiable.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

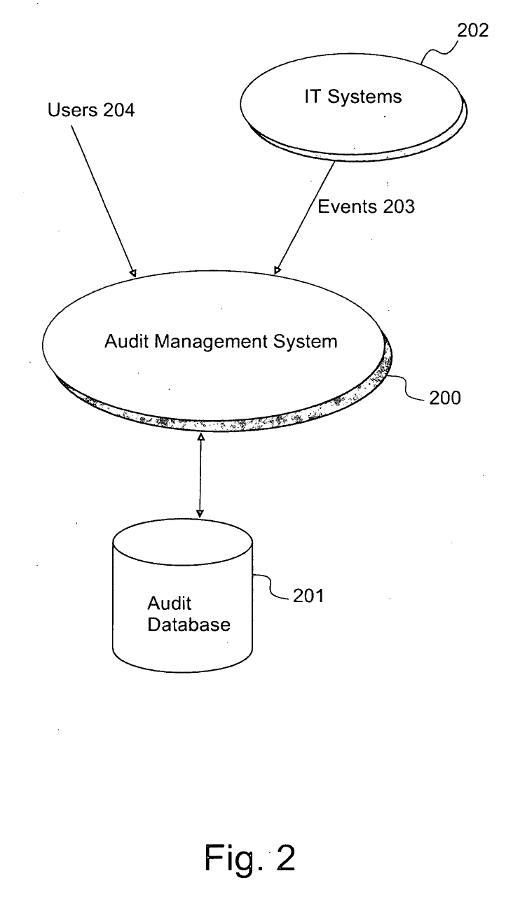

Referring to FIG. 2 herein, there is illustrated schematically an audit system according to a first specific embodiment for providing a non-repudiable audit service to a plurality of users. The audit system is based upon an audit management system 200, comprising one or a plurality of computer entities, and an audit database 201.

One or more information technology systems 202 generate events 203, which are referred to the audit management system.

An ‘event’ comprises any operation performed upon a unit of information, particularly, although not exclusively, a data file or a data record containing such information. In the context of a computer system an event may comprise any incidence of access to a data file, modification of a data file, reading a data file, sending or receiving a data file, or opening or closing a data file. An event may also be exemplified by carrying out a file handling operation, managing a file, moving a file, changing an access permission to a file, storing a file, copying a file, or such a like operation.

For example, in the context of medical data, an example of an event may constitute a doctor opening a patient record. Other examples of events may be the doctor making a record of the date that the doctor has seen the patient, or a doctor making a data entry onto a patient's medical record. Events comprise audit information, that is, information of a relatively high abstraction, rather than lower level information.

Audit information comprises information describing that an event has occurred. Audit information concerning an event is not the actual event information itself.

Another example of an event may be that a particular person opened a particular file using a particular applications program. An audit information relating to that event may record the person's name, the file name, the data and time, and the type of application program which was used to open the file.

In the example of a medical records system, an electronic patient record may comprise the basic record of treatment given to a patient. The patient record may contain data such as: when a patient booked an appointment to see a doctor; when the doctor actually saw the patient; and when treatment was delivered to the patient. Each of these items, namely the date on which the patient was booked to see a doctor, the date the patient actually saw the doctor, and the date on which treatment was given may constitute individual and separate events on a patients record. Each event may involve access or modification of the patient record, using one or a plurality of different computer systems or application programs.

Referring again to FIG. 2, one or a plurality of IT systems 202 generate a plurality of events, and those events are sent to an audit management system 200. Audit management system 200 stores audit data describing those events in audit database 201. A plurality of users 204 can query the audit management system 200 in order to check whether particular events have occurred.

The user may view a record of the events which are relevant to that user, and which are authorized to be seen by that user.

Events are generated from a variety of applications programs, in a pre-determined format for identifying an attribute set. For example, health records may take the form of a consultation record with identified attributes being:

Doctor=X

Patient=Y

Drug=Z

Diagnosis=A

In order to be able to trust the audit system, a user needs to be confident that the audit system will deliver to the user:

a list of all events which have occurred to the users record;

a record which has integrity, as evidenced by the events;

that the events themselves have integrity;

that the audit system itself including the audit database, has integrity.

The first specific embodiment may allow a user access to a set of events applicable to that user, whereby the set of events comprises a full set of events which have integrity, and the events form a consistent record of activity applicable to a user.

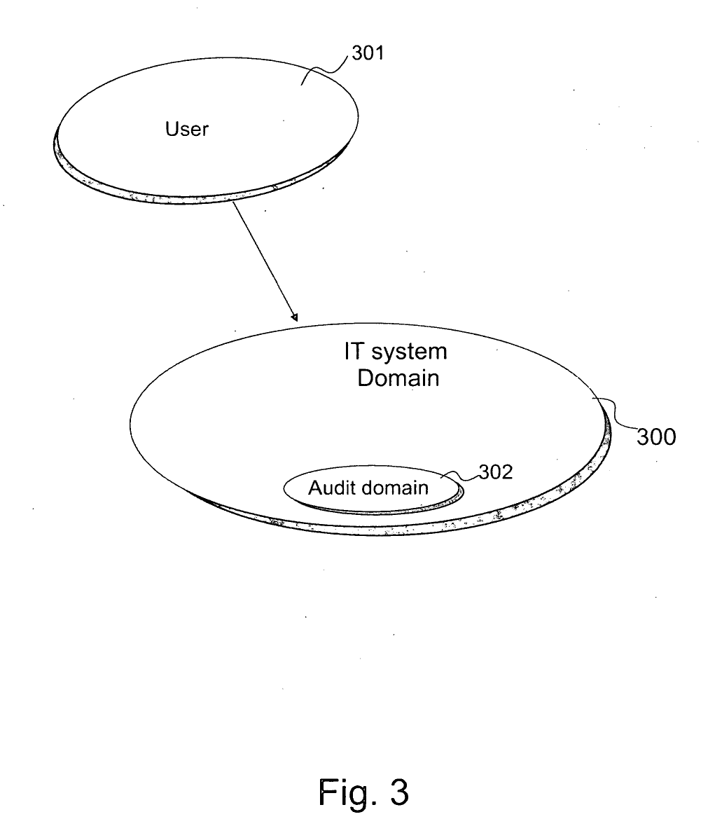

Referring to FIG. 3 herein, there is illustrated schematically a domain view of the system shown in FIG. 2. Within an IT system which has its own IT system domain 300, a user 301 is allocated their own audit domain 302. The audit domain 302 may be physically co-located with an IT system, but is logically separate from the IT system. A separate audit domain 302 is effectively created within the IT systems domain 300, and the audit system stores data so that it is searchable by the identified attributes; for example, allowing events relevant to a user (as specified in an attribute) to be extracted separately so they can be seen as an audit trail for that user.

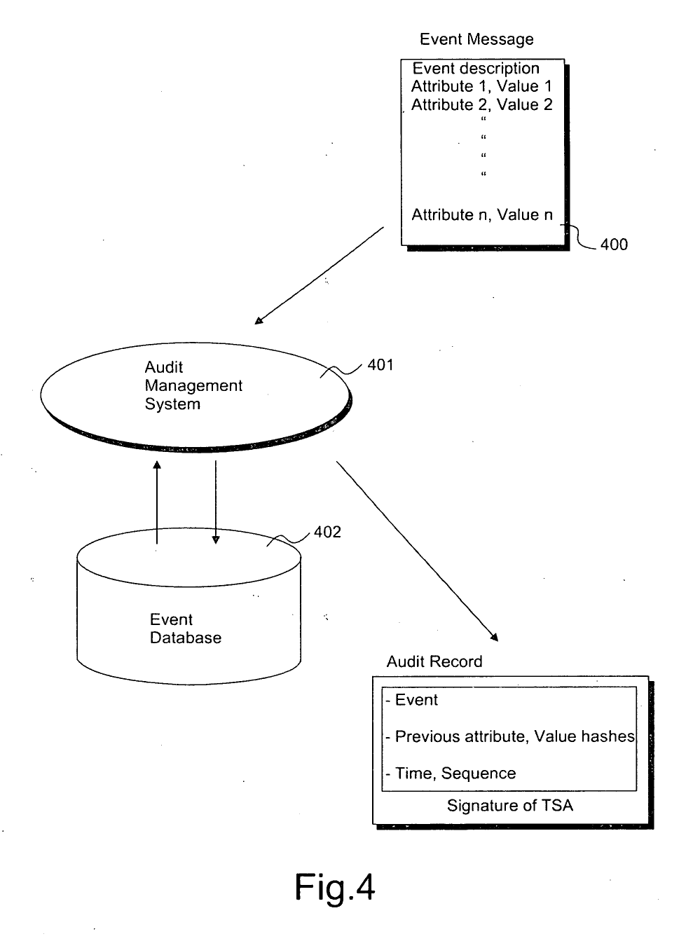

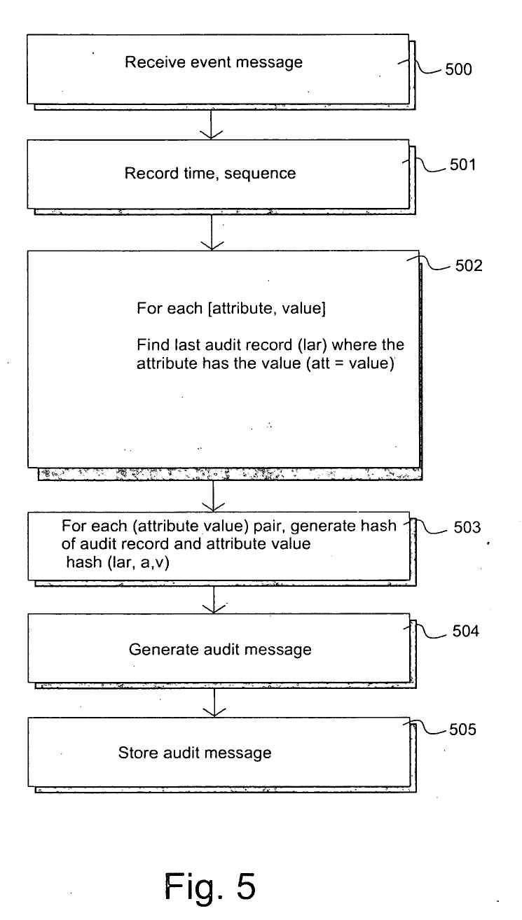

Referring to FIGS. 4 and 5 herein, there is illustrated schematically a process for generating an audit message in response to an event message generated by an IT system. An event message 400 is generated by an information system and is received 500 by the audit system. The event message has a format comprising: a description of an event; and an attribute value pair set comprising at least one attribute, and for each attribute, a corresponding respective value. The event message is sent to the audit management system 401. The audit management system is able to recognize the attributes of the event. The audit management system records the time at which the event message was received, as well as sequence information 501.

In process 502, for each value of attribute the audit management system finds the last entry in the event database 402 at which there is an existing attribute having the same value. This is a search to find the last record in the event database having the same attribute as in the presently received message. For example, in the medical records system, an example of the attribute may be ‘patient name’ and the value of that patient name may be ‘John Doe’. The audit management system searches the event database to find a previous event having a patient name of ‘John Doe’. Other examples of attributes may include: general practitioner doctor name; consultant name; hospital name. This enables the audit management system to identify all events relating to a particular attribute, for example all events relating to a particular patient, all events relating to a particular general practitioner doctor, all events relating to a particular consultant doctor, or all events relating to a hospital. Events are stored in the event database 402 in an order. This may be the order in which they were received by the audit management system, or in chronological order of the event itself. In process 503, the audit management system 401 generates a hash function of the previous audit record found having the same attribute value. The one way hash function is a unique identifier, identifying the previous record found by the audit management system of the last event having the same attribute value as that of the presently received event message. However, the hash function is generally much shorter than the previous record in data size. In process 504, the audit management system generates an audit record 403. The audit record comprises:

Data describing the original event message.

Hashes of a previous record having the same attribute value.

A data describing the time at which the event message was received by the audit management system (as recorded in process 401), and optionally, the sequence data recorded in process 401.

The above elements are sealed by applying the signature of a time stamp authority. The audit record becomes a non-repudiable record of an event and is stored in the database of the audit management system. It may also be returned to the user. The audit message is stored in process 505. The location of storage of the audit message can either be with the user, or within the audit system, or within the IT system.

Storage Sub-System

Within the audit system there is a storage system which stores notarised audit events and indexes them according to attribute value pairs. The storage system also supports the function of getting the previous digest for each attribute value pair for index chaining.

The storage system stores notarisation tree chain blocks such that they can easily be recovered for each notarised event.

User Requests

The audit management system may provide a service to users, for verifying records which apply to that user.

A user makes a request for audit records via a browser which contains a schema of the attributes which may be used to define audit events. For example, a user may request all records where their name is in a patient attribute. The request is authenticated and authorisations are checked. The request is sent to the storage system that uses its indexing to recover all relevant event records which are packaged and returned to the user. The user has a set of records which they can check either using software supplied via a third party, or from the audit service.

The audit service may run as a trusted third party audit system, or at least a system that is independent of another system which it is auditing. The audit system may be run by a third party over a network connection.

Alternatively a hardened security appliance (HSA) or a set of hardened security appliances could be used to control the time stamping and chaining portions. This would protect the key notarization operations of the audit system such that later changes to the audit data would be detectable to users and auditors. This protection may be achieved by ensuring that the keys used for signing the audit data are not accessible outside of the hardened security appliance, and that they can only be used for the notarization application. An independent party may certify these keys, and their use within the notarization application.

The hardened security appliance approach may involve several systems, with one acting as a clock and sequence counter for the initial registration. This may result in a secured token containing the time, sequence and audit event digest. This token can then be used in a second (or further) hardened security appliance, which creates the timestamp and chain information.

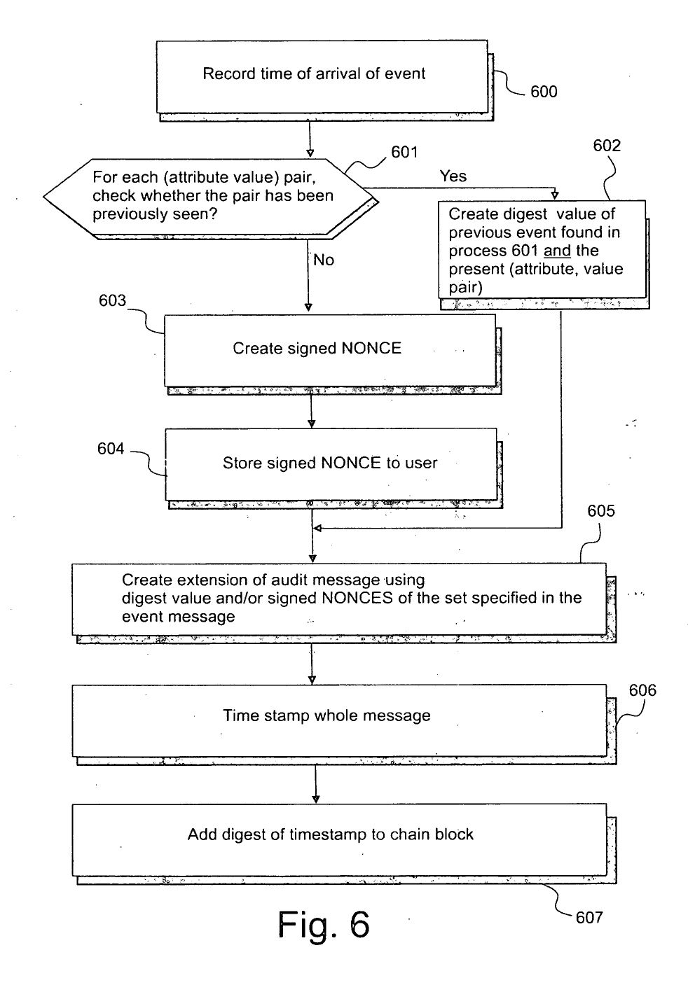

Referring to FIG. 6 herein, there is illustrated schematically processes carried out by the audit system for creating a record in the audit database.

In process 600, an event message is sent from a user or from an IT system to the audit management system. An event message may take the form of at least one attribute, and at least one value for that attribute. In process 601, it is checked for each [attribute, value] pair, whether that attribute and value has previously been seen by the audit system If it has, in process 602 a digest value is created of the previous event found in process 601, and the [attribute, value] pair. If the attribute and value has previously been seen by the audit system, then the audit system can ‘chain’ the latest event on to earlier events having the same attribute value.

However, if that attribute, value pair have not previously been seen by the audit system, then the audit system can create an audit record which is suitable for being the first audit record in a new chain of audit records relating to that attribute value. In process 603 a signed nonce is created and stored 604 instead of a digest. The signed nonce may be based on a hash table, or it could be part of an audit database indexing system.

In process 605 an extension of an audit message comprising the digest value or the signed nonce is created. The digest values or signed nonces may be created in the order in which they exist within an original event message, so as not to change the original message. In process 606, the whole audit message, including the extension is time stamped by the audit management system. Time stamping includes time stamping of both the original message, attribute digests, time, sequence, and a digest of the previous time stamp. In process 607, the digest of this time stamp (or the time stamp data) is added to a chain block. Once full, this chain block is time stamped and its digest is added to a next layer of the hash chaining system. This re-occurs, until a top layer of the hash chaining system is reached, where the chains are published

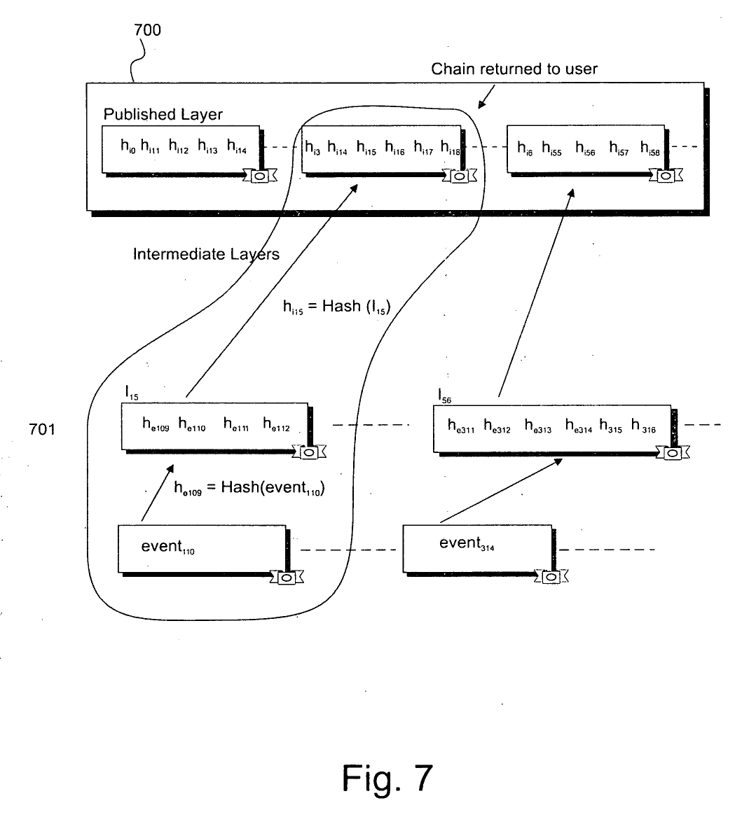

Referring to FIG. 7 herein, there is illustrated schematically a structure of an audit tree. The audit tree comprises a plurality of blocks, each block containing a list of hashes of events and/or hashes of other blocks. The blocks are arranged in an hierarchical layer structure. The audit tree has a published summary audit trail at a top level 700, and all events become traceable to this top layer 700. One or more intermediate layers 701 exists to reduce the amount of publishing, and to hide the volume of traffic from users.

Each of a plurality of hash blocks contains a list of hashes of events or hashes of blocks in the layer below, along with the hash of a previous block at that layer. The number of hashes contained in each block depends on a number of random factors. The tree structure defines minimum and maximum bounds on the size of a chain block. On creation, the size of a chain block is chosen at a random value between those bounds.

An early close value size may also be defined such that if a block is requested and it is of sufficient size, it will be closed. Blocks may also be closed on a time basis such that a summary chain block is published everyday. The user can be given an individual event, and intermediate layers and they can then check that their event is within the published summary audit trail, whilst seeing little data concerning other events. In this way, the auditor can check the overall audit trail.

Index Chaining

The user obtaining audit information from the audit management system, but who is unable to look inside the remainder of an audit trail needs to have confidence that they are getting all the relevant data from the audit system. Any lack of information within the audit trail should be visible to the user. This is achieved by ‘chaining’ of audit records for a particular attribute value.

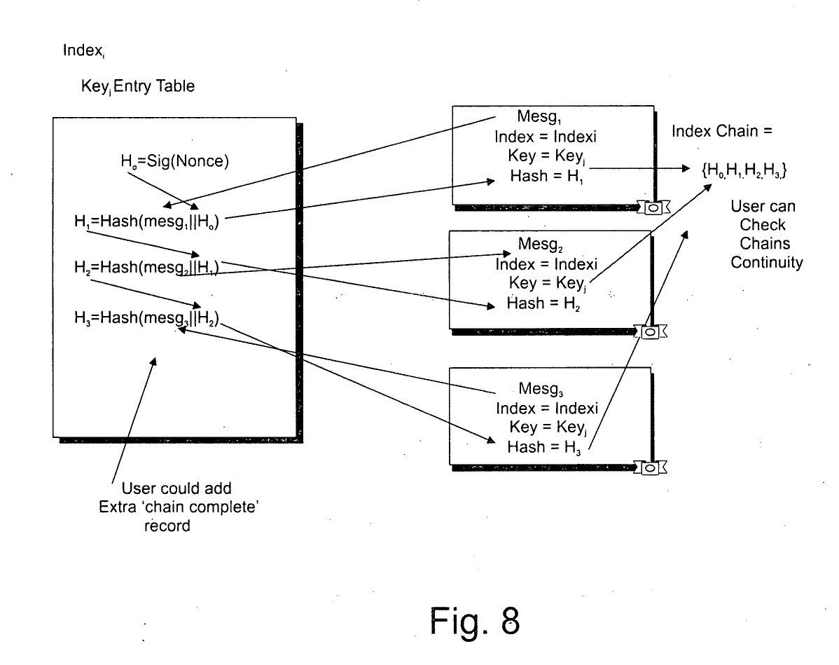

Referring to FIG. 8 herein, there is illustrated schematically packaging of series of audit events relating to a particular attribute value, in a way in which the series of audit events are chained together prior to being returned to a user. Each notarized event contains an original item of information along with the digest of the previous record for that attribute value. These are sealed by the tirestamp system at the time of entry.

The user receiving a set of entries can check the continuity of an index chain. They can look inside a notarized event and obtain the digest of the previous message with the same attribute value association. They can then check the continuity of the set of data they received. The oldest record which the user obtains should include an initial signed nonce stating it is the first such record for that attribute value association. The signed nonce seals the start of the attribute chain process. The audit system may also have archived policies, where check points are formed with the signed digests, where the system states that this is a first record in a time period. The user may wish to perform an investigation, widening the period of the audit records in which they are interested, and the check point becomes part of that chain. A check point record may be provided as an additional record created at the point of archiving, and may as such be further up an index chain, thereby complicating any invalidation algorithm.

Where a user is concerned that they may not be seeing the latest set of records, they can create an end point request, such that this entry should be the last record they see. An end point marker and is sealed into an audit trail, and this is confirmed in the audit tree.

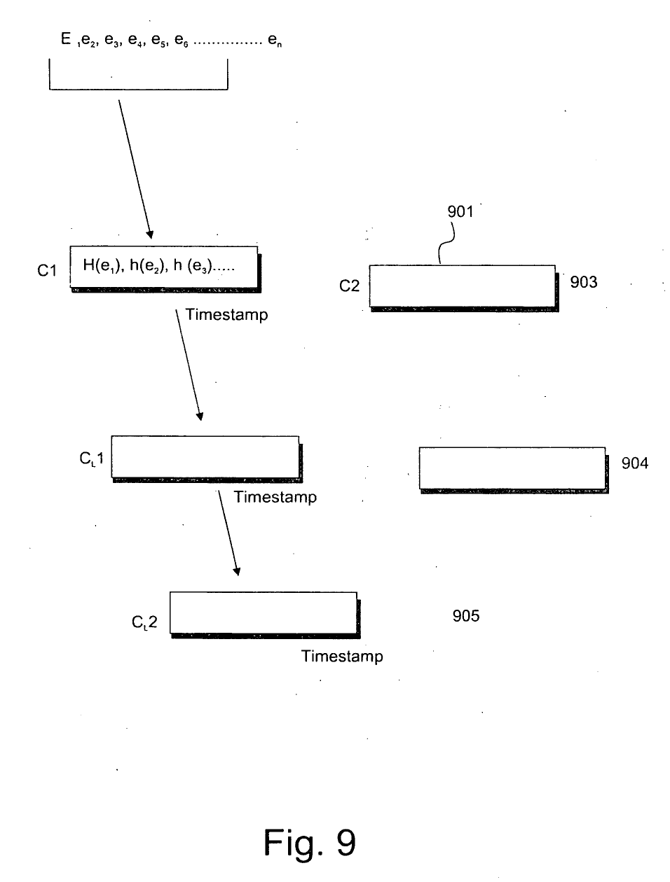

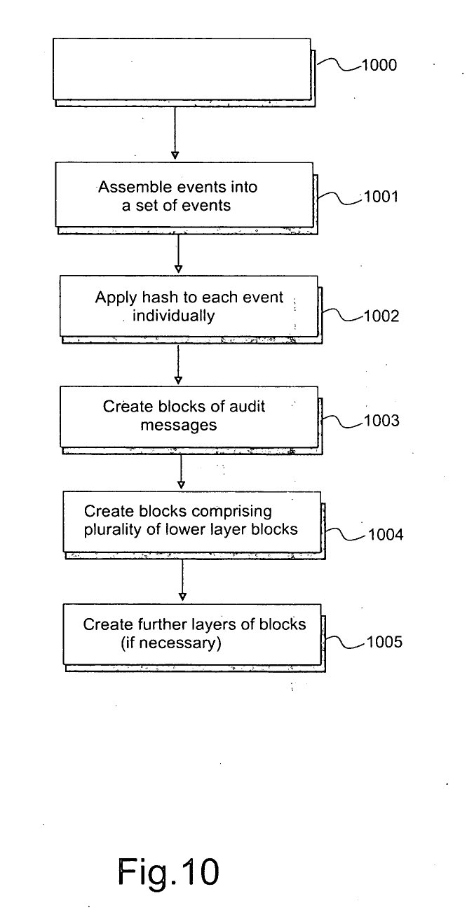

Referring to FIGS. 9 and 10 herein, there is illustrated schematically creation of a summary of a chain of events e₁ . . . eₙ.

Events e₁, e₂, e₃ . . . eₙ arrive from an IT system sequentially and are received 1000 by the audit system. The events are assembled 1001 into sets of events. As each event arises, a hash function is generated of the event 1002. Hash functions are divided in to a plurality of blocks 900, 901 such that each block comprises a plurality of audit messages created in process 1003.

As event messages continue to arrive, audit messages are generated, which create further blocks. The lengths of the blocks may be random or predetermined.

A plurality of blocks may be chained together to form a chain of blocks in a next layer 904, and the chains of blocks may be further chained together in one or more subsequent layers 905. The amount of blocks of an intermediate layer 904 found chained in a block of a highest layer 905 is selected such that blocks are generated in the highest layer 905 sufficiently regularly to be able to provide an up to date audit trail, but the amount of blocks generated is not so large such as to be difficult to search. In each layer, individual blocks are timestamped at their time of creation. This may have the effect of cutting down the amount of data which needs to be checked to find a particular event, but retaining non-repudiation.

Verification of an Event from an Audit Chain

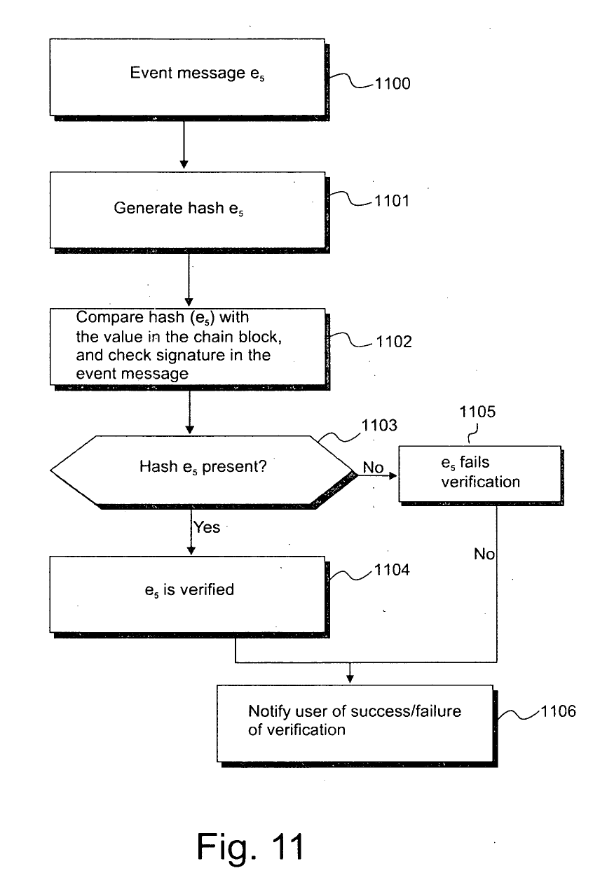

Referring to FIG. 11 herein, there is illustrated schematically process steps carried out for verifying an event message. In the example shown an event message e₅ is selected for verification in process 1100. A user presents the event message e₅ to the audit system. The audit system generates a hash of e₅ in process 1101, and compares the hash (e₅) with the content of each of the chain blocks at the highest level of the audit tree. The hash (e₅) may be compared with a block of data having a timestamp corresponding to a timestamp of the event message, thereby avoiding searching through a large number of blocks.

If the digest hash (e₅) is present in the chain block having a corresponding timestamp in process 1103, then the event e₅ is verified 1104. However, if the digest hash (e₅) cannot be found in the block having a timestamp corresponding with the timestamp of the event e₅ then the service may go on to perform a search of other blocks having timestamps before or after the timestamp on the event message e₅ to find a match. If no match can be found, or if a match is found, but having a different timestamp to the timestamp of the event message e₅, then the event message e₅ fails verification in process 1105, and a message to the user noting the failure for verification is sent from the service to the user in process 1106.

In order to verify a message e, for example a message e₅ it is not necessary to have access to other events surrounding the event e₅. It is only necessary to have the event message e₅ and a top level data block of the audit tree, containing the digest of e₅. Consequently, a message e₅ can be verified without exposing any other event messages to a user wishing to verify an event message e₅.

The top level 905 of the audit tree may be publicly available in the context of the audit system. For example, if the audit system is restricted within a particular business or enterprise, then the top level of the audit tree may be generally available to anyone within that organization. If the audit system is provided as a publicly accessible system, then the top level 905 of the audit tree may be publicly available, for example over the internet. Since the blocks of the top level of the audit tree are timestamped, users can have confidence that the top level blocks have integrity.

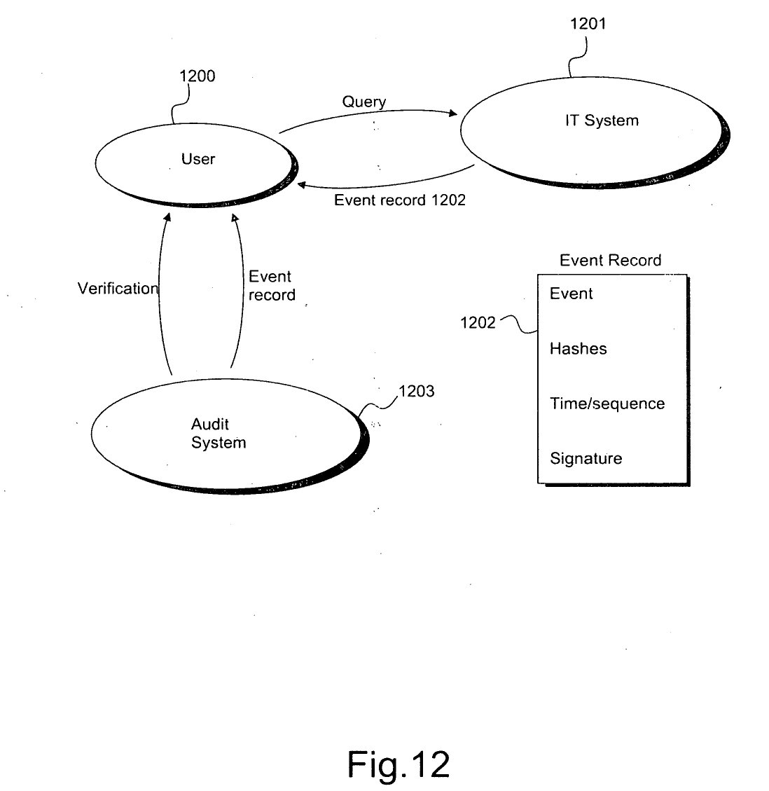

Referring to FIG. 12 herein, there is illustrated schematically an example of verification of an event record, specific to a medical record system. A user 1200 wishes, for example, to find evidence that his doctor referred the user to a particular hospital. The user queries the audit system which is co located with the hospital IT system 1201, which returns an event record 1202 to the user. The event record comprises an event data, a set of hashes, a time/sequence data, and is signed as described herein before. In this case, the event record is a record of the doctor referring the user to a particular hospital.

User 1200 wishes to verify that the event record is a true record of the doctor's referral, and submits the event record to audit system 1203 for verification. The user may request that the audit system verifies the record. Alternatively, the user, who will have a package of audit records retrieved from the audit system co located with the hospital IT system, the user can use software, for example an applett, provided as part of an audit service, to validate the event. The audit system verifies the event record by comparing the event record with its audit tree, and returns a verification result to user 1200 as a service. Since audit system 1202 may be run by an independent trusted third party, the user has a reliable indication of whether the event record received from the IT system 1201 is true or not.

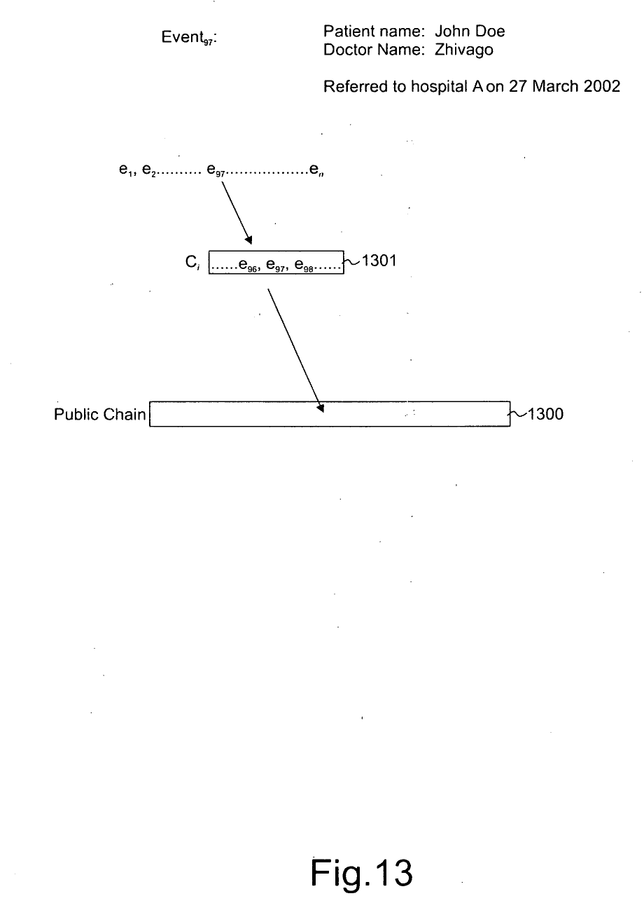

Referring to FIG. 13 herein, there is illustrated schematically checking carried out on the audit records by an audit system on receiving an event record from a user. The event record may take the form of an attribute of a patient name, and an attribute of a doctor name, each having a value, and details of an event, in this case a referral to a hospital.

The audit record is processed by the audit system as follows. The audit system checks the timestamp of the audit record in process 1400. The audit system checks whether the event is part of an audit trail in process 1401. The audit system does this by generating a hash of the event e₉₇, and searching for it in blocks within levels of the audit tree. The event e₉₇ is not a member of the public chain 1300, but rather the block 1301 below the public chain is a member of the public chain, and this gives a route to showing that event e₉₇ is part of the public chain. The hash of e₉₇ is a member of the public chain, via intermediate block 1301, which is also hashed. Therefore, the information in the public chain 1300 representing event e₉₇ is a hash of e₉₇ and other hashes.

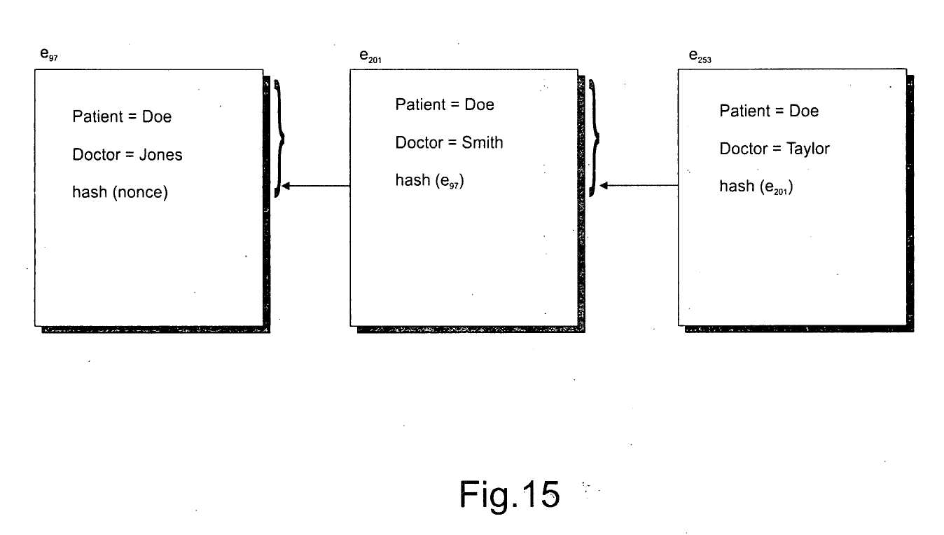

Referring to FIG. 15 herein, there is illustrated schematically a specific example of chaining of set of event records returned from an IT system to a user. Each event record e₉₇, e₂₀₁, e₂₅₃ contains a hash function of a preceding audit record within the sequence. By chaining the audit records in this way, the user can verify from the most recent record, that all the records relating to that particular attribute, in this case a patient, are contained within the set. To check this, the user submits the set of audit records to the audit system and the audit system checks the hashes as follows.

The audit system generates a hash of the first audit record e₉₇ and checks this against the hash (e₉₇) contained in the second audit record e₂₀₁. Having been satisfied that the hash contained in the second audit record e₂₀₁ is the same as that generated from the first audit record e₉₇, the audit system then prepares a hash of the second audit record e₂₀₁ and compares this with the hash contained the third audit record 253, in this case being the final audit record. If the hash of the second audit record hash (e₂₀₁) is the same as the hash in the final audit record, then the chain is verified as being complete.

In the aforementioned embodiments, there is provided a chaining which allows an integrity check grounded in a time stamp, for performing searches on indexes.

The methods and embodiments disclosed herein may provide a method of creating a non-repudiable chain of audit records relating to a particular attribute, said method comprising: for a particular attribute value, time stamping an original item of event information and a digest of an event information of a previous event for that attribute value.

The methods and embodiments herein may provide a method for providing a non-repudiable audit record for a set of events, said method comprising: for each event of a chain of said events, generating a hash function of the event; dividing a plurality of said hash functions into a plurality of blocks, such that each said block comprises a plurality of said audit messages; chaining together a plurality of said blocks to form a chain of blocks. Each said block within a said layer is time stamped at a time of creation of said block. Said plurality of blocks are further chained together in a layer structure each layer being time stamped at its time of creation.

The methods and embodiments disclosed herein may be particularly appropriate for audit, rather than for general databases, since audits tend to be “append only”, and with the techniques disclosed herein, tampering with audited records by undoing or removing records from the time stamped structures is guarded against.

1. A method for verifying at least one event record, said method comprising:
receiving a said event record from a user;
retrieving an audit record corresponding to said at least one event record;
retrieving a full set of event records corresponding to said audit record, and for a same attribute value as specified for said event record;
for each said event record of said set, generating a digest of said event record and searching for said digest value in an audit record relating to a next event record in said set of event records; and
confirming whether said event record is true or false, by comparing said digest of said event record with a digest value found in said audit record.

2. The method as claimed in claim 1, further comprising:
verifying whether a set of event records presented by a user comprises a full set of event records or not.

3. The method as claimed in claim 1, wherein said operation of chaining is carried out by a secure hardware device.

4. A service for verifying at least one event record, said service comprising the operations of:
(i) receiving a request for events according to a specified attribute value;
(ii) retrieving a full set of records according to said specified attribute value contained in said request;
(iii) generating a digest value for a record of said set; and
(iv) checking that said generated digest value matches a digest value contained in another record of said set.

5. The service as claimed in claim 4, further comprising:
repeating items (iii) and (iv) for each record in the set, until a final record in the set is reached.

6. The service as claimed in claim 4, wherein said item (ii) of retrieving a full set of records comprises retrieving:
at least one audit record; and
at least one event record.

7. The service as claimed in claim 4, wherein said item (ii) comprises:
retrieving a series of audit records in which each audit record in the series comprises a digest value of an event and a digest value of a preceding event in said series.

8. A method of producing an audit record of at least one event, said method comprising:
creating a record comprising:
data relating to said event;
a digest data;
a time data; and
signing said event data, digest data, and time data.

9. The method as claimed in claim 8, further comprising:
creating a sequence data; and
signing said event data, said digest data, said time data, and said sequence data.

10. An audit record comprising:
an event data describing an event;
a digest data;
a time stamp data; and
a digital signature.

11. The audit data as claimed in claim 10, wherein said digest data comprises:
a unique identifier data identifying a previous event having a same attribute value as said event.

12. The audit data as claimed in claim 10, wherein said digest data comprises:
a hash of a nonce value.

13. The audit data as claimed in claim 10, wherein said digest data comprises:
a hash of a previous audit record having a same attribute as said audit record.

14. The audit record as claimed in claim 10, further comprising:
a sequence data describing a position of said event within a sequence of events.

15. The audit record as claimed in claim 10, wherein said digital signature comprises a digital signature of a time stamp authority.

16. A method of generating a verifiable set of audit records, said method comprising:
generating a first audit record comprising at least one attribute having a value and a unique identifier data;
generating a second audit record comprising,
a second event data;
said attribute having said attribute value; and
a digest of said first audit record.

17. The method as claimed in claim 16, further comprising a generating a terminating audit record for terminating said set of audit records.

18. The method as claimed in claim 16, wherein said unique identifier data of said first audit record comprises a hash of a nonce.

19. A method of verifying that a set of audit records consists of a complete set, said method comprising:
for a first said audit record;
extracting a digest value from said audit record;
selecting an immediately preceding audit record from said set;
generating a digest value of said immediately preceding audit record;
comparing said generated digest value with said digest value of said first audit record.

20. The method as claimed in claim 19, further comprising:
if said generated digest value of said immediately preceding audit record is identical to said digest value of said selected audit record, then verifying said selected audit record as true.

21. The method as claimed in claim 19 further comprising:
if said generated digest value of said immediately preceding audit record is not identical to said digest value of said selected audit record, then verifying said selected audit record as false.

22. An audit system comprising:
an event database capable of storing a plurality of event records, each said event record evidencing an event;
an audit management system, said audit management system operable for generating an audit record, said audit record comprising:
data relating to said event; a digest of said event data; a timestamp data;
and a digital signature.

23. A computer program comprising program instructions for:
creating a record comprising,
data relating to an event;
a digest data;
a timestamp data; and
a signature applied to said event data, digest date and timestamp data.

24. A computer programmed in accordance with the computer program of claim 23.

25. A computer program comprising program instructions for generating a verifiable set of audit records by;
generating a first audit record comprising at least one attribute having a value and a unique identifier data;
generating a second audit record comprising;
a second event data;
said attribute having said attribute value; and
a digest of said first audit record.

26. A computer programmed in accordance with the computer program of claim 25.

27. A computer program comprising program instructions for verifying that a set of audit records consists of a compete set, by:
extracting a digest value from an audit record;
selecting an immediately preceding audit record from said set of audit records;
generating a digest value of said immediately preceding audit records; and
comparing said generated digest value with said digest value of said first audit record.

28. A computer programmed in accordance with the computer program of claim 27.

29. A computer program comprising program instructions for providing a verifiable record of an event by:
receiving an event message, said event message comprising data describing an event;
creating an audit record from said event data, said audit record comprising:
said event data;
a chaining data identifying a position of said audit record in a chain of said audit records;
a timestamp data indicating a time of receipt of said event data; and
a digital signature.

30. A computer programmed in accordance with the computer program of claim 29.

31. A computer program comprising instructions for verifying at least one event record by:
receiving a said event record from a user;
retrieving an audit record corresponding to said event record;
retrieving a full set of event records corresponding to said audit record, and for a same attribute value as specified for said event records;
for each said event record of said set, generating a digest of said event record and searching for said digest value in an audit record relating to a next event record in said set of event records; and
confirming whether said event record is true or false, by comparing said digest of said event record with a digest value found in said audit record.

32. A computer programmed in accordance with the computer program of claim 31.

33. An audit service for providing a verifiable record of an event, said audit service comprising the operations of:
receiving an event message said event message comprising data describing an event;
creating an audit record from said event data, said audit record comprising:
said event data;
a chaining data identifying a position of said audit record in a chain of said audit records;
a timestamp data indicating a time of receipt of said event data by said audit service; and
a digital signature.

34. The service as claimed in claim 33, further comprising:
returning said audit record to a user of said service.

35. An audit service for providing a verifiable record of a plurality of events, and an integrity between those events, said audit service comprising the operations of:
receiving a plurality of event messages, each said event message comprising data describing a corresponding respective event;
creating a respective audit record from each of said event messages, said audit record comprising:
an event data contained within said event message;
a chaining data identifying a position of said audit record in a chain of said audit records;
a timestamp data indicating a time of receipt of said event message by said audit service; and
a digital signature.

36. A method of creating a non-repudiable chain of audit records relating to a particular attribute, said method comprising:
for a particular attribute value, time stamping an original item of event information and a digest of an event information of a previous event for that attribute value.

37. A method for providing a non-repudiable audit record for a set of events, said method comprising:
for each event of a chain of said events, generating a hash function of the event;
dividing a plurality of said hash functions into a plurality of blocks, such that each said block comprises a plurality of said audit messages;
chaining together a plurality of said blocks to form a chain of blocks.

38. The method as claimed in claim 37, comprising time stamping each said block within a said layer at a time of creation of said block.

39. The method as claimed in claim 37, further comprising further chaining said plurality of blocks together in a layer structure, and time stamping each layer at its time of creation.
